(19) United States
(12) Patent Application Publication
(10) Pub. No.: US 2026/0253429 A1
(43) Pub. Date: Aug. 27, 2026

(54) SYSTEM AND METHOD FOR AUTONOMOUS SAFETY MONITORING AND CONTROL OF VEHICLES IN TRANSIT

(71) Applicant: 7980302 CANADA INC., Montreal (CA)

(72) Inventor: Raphael JEAN, Montreal (CA)

(21) Appl. No.: 19/549,465

(22) Filed: Feb. 25, 2026

Related U.S. Application Data
(60) Provisional application No. 63/763,033, filed on Feb. 25, 2025.

(51) Int. Cl. G06V 20/58; G06V 10/25; G06V 10/26; G06V 10/32; G06V 10/764; G06V 10/82; G06V 20/40; G06V 20/56; G08G 1/0967

(52) U.S. Cl. CPC G06V 20/582; G06V 10/25; G06V 10/26; G06V 10/32; G06V 10/764; G06V 10/82; G06V 20/40; G06V 20/588; G08G 1/096725; G08G 1/096766

(57) ABSTRACT

A system and method for autonomously monitoring and/or controlling driving operations that includes a controller and a memory unit; a camera that provides real-time forward-facing video stream of the road; a notification device; a vision-based neural network module. The controller configured with computer executable instructions to operatively: receive the real-time forward-facing video stream of a currently-traveled road; convert the real-time video stream into road digital image data; identify a relevant portion of the road to be tracked during travel; determine RoI image data within the tracked relevant portion of the road; crop the RoI image data to provide RoI sub-image data; supply the cropped RoI sub-image data to a vision-based neural network module that operates on limited pixel size image data for detecting an OoI; track the detected OoI during travel to monitor driving operations of the vehicle; and provide real-time status of the monitored driving operations.

### CROSS-REFERENCE TO RELATED APPLICATIONS

The present application claims priority to U.S. Provisional Patent Application No. 63/763,033, filed on Feb. 25, 2025, the entirety of which is incorporated herein by reference.

### FIELD OF TECHNOLOGY

The technology presented herein generally relates to vehicle operations and, in particular, to autonomous monitoring of vehicles in transit.

### BACKGROUND

Recently, vehicles have been equipped with Intelligent Speed Adaptation (ISA) and Autonomous Driving (AD) technologies to provide autonomous-based safety features during travel. Such technologies often require multiple sensors, multiple cameras, high-performance data processors/accelerators as well as specific circuit configurations for override control of steering subsystems, brake subsystems, accelerator subsystems and/or engine and transmission subsystems.

However, for a wider range of vehicles that are not originally manufactured with such technologies, it may be both cost-prohibitive and task-intensive to provide these vehicles with the equipment and configurations necessary to accommodate and implement such technologies. Accordingly, there is an interest in providing vehicles with expeditious, responsive, and cost-sensitive autonomous safety monitoring features.

### SUMMARY

Embodiments of the present technology have been developed based on the interest in providing vehicles expeditious, responsive, and cost-sensitive autonomous safety monitoring features. The solution provided by the present technology improves developer's current products directed to GPS and GNSS-based solutions by enabling the addition of new features, such as adapting to the maximum allowed speed based on detected road work zones, variable speed limits, pedestrians, cyclists, relative speed of other vehicles, and hazardous weather conditions. This is achieved while keeping the hardware implementation at an affordable price-point.

With this said, an object of the present technology is directed to a system for autonomously monitoring and/or controlling driving operations of a vehicle that comprises a controller communicatively-coupled to an associated memory unit, in which the controller is configured with computer executable instructions to operatively: receive a real-time forward-facing video stream of a currently-traveled road from a camera; convert the real-time video stream into road digital image data; identify a relevant portion of the road to be tracked during travel based on the road digital image data; determine region-of-interest (RoI) image data based on the tracked relevant portion of the road; crop the RoI image data to provide RoI sub-image data comprising a reduced pixel number size of the road digital image data; supply the cropped RoI sub-image data to a vision-based machine-learning algorithm (MLA) trained to detect an object-of-interest (OoI); track the detected OoI during travel to monitor the driving operations of the vehicle; and generate status of the monitored driving operations on a near real-time basis.

In related aspects of the system of the present technology, the system is configured to provide that: the MLA comprises a vision-based neural network module (NNM), the near real-time basis of reported status comprises less than 1 second, a notification device is communicatively-coupled to the controller to receive and report the near real-time status of the monitored driving operations, and that the controller is further configured to detect electrical analog or electrical digital signals generated by the vehicle acceleration pedal to override driving operations of a driver by limiting the speed of the vehicle based on the monitored driving operations status.

A related object of the present technology is directed to a computer-implemented method for autonomously monitoring and/or controlling driving operations of a vehicle that comprises receiving a real-time forward-facing video stream of a currently-traveled road; converting the real-time video stream into road digital image data; identifying a relevant portion of the road to be tracked during travel based on the road digital image data; determining region-of-interest (RoI) image data within the tracked relevant portion of the road; cropping the RoI image data to provide RoI sub-image data comprising a reduced number of pixels of the road digital image data; supplying the cropped RoI sub-image data to a machine-learning algorithm (MLA) trained to detect an object-of-interest (OoI); tracking the detected OoI during travel to monitor the driving operations of the vehicle; and generating near real-time status of the monitored driving operations.

In related aspects of the computer-implemented method of the present technology, the method provides that: the MLA comprises a vision-based neural network module (NNM), the near real-time reporting status comprises less than 1 second, the reporting of the near real-time status of the monitored driving operations to a notification device communicatively-coupled to the controller, the controller is further configured for detecting electrical analog or electrical digital signals generated by the vehicle acceleration pedal to overriding driving operations of a driver by limiting the speed of the vehicle based on the monitored driving operations status.

The exemplary system and method implementations described by this disclosure are intended to aid the reader in understanding the principles and relevant concepts of the present technology. In no way, however, are the specifically-described implementations intended to limit the scope of the present technology.

Moreover, unless expressly provided otherwise, the words “first”, “second”, “third”, etc. have been used as adjectives only for the purpose of allowing for distinction between the nouns that they modify from one another, and not for the purpose of describing any particular relationship between those nouns. It should also be understood that terms relating to the position and/or orientation of components such as “upper”, “lower”, “top”, “bottom”, “front”, “rear”, “left”, “right”, are used herein to simplify the description and are not intended to be limitative of the particular position/orientation of the components in use.

Furthermore, it should be understood that the use of the phrase “at least one of A and B” is intended to mean A only, B only, or both A and B.

Additional and/or alternative features, aspects and advantages of implementations of the present technology will become apparent from the following description, the accompanying drawings and the appended claims.

### BRIEF DESCRIPTION OF THE DRAWINGS

The drawings presented herewith are for illustrating various implementations of articles, products, methods, and apparatuses described in the present specification. It should be understood that, unless explicitly identified, the drawings should not be assumed to be to scale, as various features may be exaggerated, scaled down, or omitted for purposes of clarity. Accordingly:

FIG. 1 depicts a system for autonomously monitoring driving operations of a vehicle, in accordance with embodiments of the present technology;

FIG. 2A depicts a process for autonomously monitoring driving operations of a vehicle, in accordance with embodiments of the present technology;

FIG. 2B depicts a process for generating region-of-interest (RoI) sub-image data, in accordance with embodiments of the present technology;

FIG. 2C depicts a process for detecting an object-of-interest (OoI), in accordance with embodiments of the present technology;

FIGS. 3A-3D depict images corresponding to results of the processing tasks of the present technology;

FIG. 4 depicts a functional block diagram of an artificial intelligence (AI)-based machine learning algorithm (MLA) platform, in accordance with embodiments of the present technology; and

FIG. 5 depicts an exemplary high-level implementation of the system, in accordance with embodiments of the present technology.

### DETAILED DESCRIPTION

The examples and conditional language disclosed herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes that may be substantially represented in non-transitory computer-readable media and so executed by a computer or processor, whether or not such computer or processor is explicitly shown.

The functions of the various elements shown in the figures including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU), neural processing unit (NPU), graphics processing unit (GPU), tensor processing unit (TPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With this said, the present technology will be described herein with respect to a system and computer-implemented method for providing vehicles with expeditious, responsive, and cost-sensitive autonomous safety monitoring features. The present technology allows for reliable detection of traffic signs, road work zones and hazardous road conditions more efficiently, thus allowing to implement those features on less expensive hardware than previously possible.

Generally speaking, the autonomous safety monitoring features of the present technology are premised on vision-based situational awareness concepts. Such concepts take advantage of the fact that the operations are based on a live video stream from a road facing camera. So, instead of processing an entire image for each and every frame, it is possible take advantage of the fact that there is not a lot of difference between two frames coming from the road facing camera and the way that human vision works, humans cannot normally see everything in their field of view and rely heavily on saccade movements to resolve objects of interest.

This enables processing to be performed at optimized speeds via a vision-based neural network module to identify, track, and monitor an object of interest along the road during travel. The status of the monitored object of interest is then reported to the driver in near real-time via a notification device. The object of interest may comprise traffic-related signs, drivable areas, hazardous road conditions, etc. For instance, when reading a speed limit sign, the area is the set of pixels around the last detection of the speed limit sign. When there is no speed limit signs being tracked, a lane tracker module may be employed to estimate where the center of the road is located. In order to improve tolerance to errors, a scan is performed around that particular location using a pattern, such as “top left, top right, bottom center, full picture”.

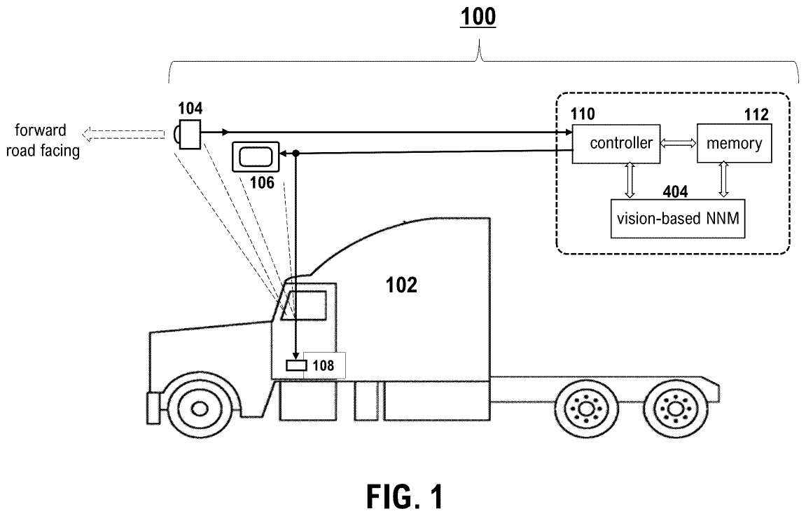

Accordingly, FIG. 1 depicts system 100 for autonomously monitoring driving operations of a vehicle 102, in accordance with embodiments of the present technology. As shown, the configuration of autonomous monitoring system 100 comprises a controller 110 with an associated memory unit 112 comprising instructions to execute a machine learning algorithm (MLA), such as a vision-based neural network module (NNM) 404. The controller 110 is also communicatively coupled to an onboard camera 104, a notification device 106, and an accelerator pedal controller or ECU 108 of vehicle 102.

In particular, controller 110 comprises a processor or a plurality of cooperating processors while the associated memory unit 112 comprises read-only memory (ROM) for executable instruction storage and random access memory (RAM) for data processing storage. The camera 104 is configured to provide a real-time, forward-facing video stream of the road currently-traveled by vehicle 102 to the controller 110. The camera 104 may be embodied by a HD visible light camera, an infrared camera, and/or a depth-sensing camera.

In this configuration, the controller 110 receives the real-time video stream and operates to convert it into road digital image data. The road digital image data is converted into a format that is suitable for vision-based neural network processing such as, for example, an RGB format having a pixel size of 1920×1080.

The controller 110 is also configured to identify a relevant portion of the road to be tracked during travel from the road digital image data. The identified relevant portion of the road is directed to focusing on a segment of the road digital image data that is determined to likely contain a region-of-interest (RoI) within the road digital image data. That is, first glance at the whole picture, in order to find where to road is located, and where it is likely to find signs. Then keep looking until either the road or a sign is detected. This step can be done without having processed any image, at initialization for instance by well-known techniques, such as bilinear interpolation, nearest neighbor, down-sampling, etc.

In some embodiments, the controller 110 defines a “road-end bounding region” (REBR) as a far-field bounding box derived from detected road geometry (e.g. lane center and/or lane boundaries). The REBR is positioned proximate to the far-field portion of the drivable corridor and may serve as the seed region within which a V-scan process described below is executed.

The RoI provides a region of the road digital image data with a lower pixel size that is to be processed by the vision-based neural network module (NNM) 404 instead of processing the entire high resolution RGB 1920×1080 road digital image data. As such, controller 110 is configured to determine the RoI image data by scanning the identified relevant portion of the road. Once the relevant portion of the road is identified, such as a center of the road, or the REBR, the system will keep on tracking the center of the road, or the REBR, and begin an RoI search. The scanning process of the RoI search may be executed by scanning various portions of the identified relevant portion of the road, such as, for example scanning top left, top right, bottom left, bottom right, and center portions and/or scanning the relevant portion of the road from top to bottom in a V-shaped pattern.

Armed with the determined RoI image data, the controller 110 is further configured to crop the RoI image data to provide RoI sub-image data focusing on the RoI with a reduced pixel size number. That is, the cropping of the RoI image data comprises disregarding pixels of the road digital image data that contain image data outside of the focused RoI. In some embodiments, the cropped RoI sub-image data may be resized to provide a reduced number of pixels of the cropped RoI sub-image data. For example, the cropped ROI sub-image data may be extracted as 1024×320 pixels within the selected region and then resampled to 512×160 pixels to match the neural network input (described in detail below). Such resizing may include techniques, such as, down-sampling, adjusting scaling factor, adjusting resolution, etc. In some embodiments, the resizing of the cropped RoI sub-image data includes maintaining the same aspect ratio as the road digital image data.

In the disclosed implementation, the vision-based NNM 404 comprises an input size of only 512×160 pixels, while the camera resolution is 1920×1080. This means that only 4% of the available pixels are processed at any given time. This also means that the disclosed implementation can operate over 25 times faster than conventional techniques that employ a square object detector to process full high resolution images. By way of example, recent studies indicate that AI-based dash cams that process full high resolution road images are capable of providing notification alerts to drivers on the order of several seconds. Specifically, depending on the particular dash cam model used, the mean time to process and alert a driver of following a vehicle too close ranges from approx. 13 s to 26 s. (See, e.g., Virginia Tech Transportation Institute (VTTI), AI Dash Cam Benchmark Testing, Jun. 30, 2023; see also, https://vtechworks.lib.vt.edu/server/api/core/bitstreams/c08e47fb-dae3-48ab-9a30-ce266becf566/content: AI Dash Cam Testing, Final Report: Table 17). However, by focusing on processing the lower pixel sized RoI containing relevant road artifact data (e.g., object-of-interest), the disclosed implementation is capable of providing notification alerts on the order of milliseconds; for example, from approx. 10 ms to 325 ms.

Turning back to the configuration of system 100, the cropped RoI sub-image data is supplied to the vision-based NNM 404 for detecting an object-of-interest (OoI). In some embodiments, the cropped RoI sub-image data is further processed by controller 110 to determine coordinates of the detected OoI within the cropped RoI sub-image data and transform the coordinates of the detected OoI to correspond and map to the road digital image data. Additionally, OoI bounding boxes may be established to facilitate tracking of the detected OoI in coordination with the mapped coordinates of the road digital image data.

In this manner, once an object of interest is located, such as a sign, the RoI becomes a window of the vision neural network size around the OoI. This, window allows to reach the highest amount of digital zoom achievable without losing information. Once the OoI is confirmed (or inferred), the process returns back to capturing the high-resolution real-time video stream. The OoI may comprise traffic-related signs, such as, for example, pedestrians, cyclists, speed signs, road work zone signs, lane closure signs, directional signs, toll signs, detour signs, etc. The OoI may also comprise also comprise drivable areas, such as, for example, roads, streets, lanes, highways, etc. The OoI may further comprise hazardous road conditions, such as, for example, snow, ice, standing water, immobile vehicles, road obstacles, potholes, etc.

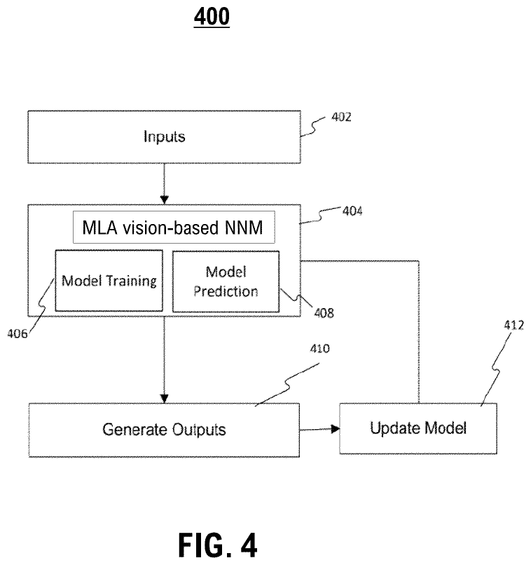

As noted above, the vision-based NNM 404 of autonomous monitoring system 100 is based on an AI machine deep learning model that is configured to receive and process RoI sub-image data having a reduced pixel size number to optimize processing speeds in detecting an OoI. By way of illustration, FIG. 4 depicts a functional block diagram of an AI-based machine learning platform 400, in accordance with embodiments of the present technology.

As shown, platform 400 is configured to provide data inputs 402 to a machine learning model, namely, MLA vision-based NNM 404 for performing model training 406 and model predictions 408. It will be appreciated that machine learning models may include one or more models or submodels that are implemented in either a parallel or serial manner (e.g., the output of one machine learning model is an input to another machine learning model. In some embodiments, machine learning models may include a deep learning model in addition to a large-language model. Large-language models, which may include one or more transformers, may refer to models capable of utilizing large datasets to understand, generate, and predict content.

Moreover, in the case of deep learning models, such as neural network NNM 404, they encoder and/or decoder networks as well as other mechanisms to are incorporated to learn contextual relationships. In some embodiments, the machine learning model has an image-to-text model trained on a set of images. An image-to-text model may refer to any machine learning model configured to generate images with guidance of a text input. For example, image-to-text machine learning models may generate text output from an image, such as a captions, text prompts, etc.

Turning back to FIG. 4, the data inputs 402 to MLA vision-based NNM 404 comprise image data having a reduced pixel size. The input image may include transmitting pixel values corresponding to the input image, as well as any metadata such as file information, GPS location, timestamps, and relevant details that can be inferred from the metadata, such is daytime, nighttime, or twilight. Machine learning models may learn features from input images, including styles, tones, context contained within images, shapes, etc. The image data input is forwarded to MLA vision-based NNM 404 for model training 406 and model predictions 408.

Specifically, the model prediction module 408 is configured to perform inferences based on any inputs provided to the model, including inputs not used for training. Inference may refer to using the trained machine learning model to generate predictions or outputs (e.g., an output image in the example of a text-to-image machine learning model).

The model training module 406 is configured to perform training of the model based on a set of images. The set of images may include one or more images in which each image in the data set may have similar or different features to one another. As such, features in different images may belong to different classifications or images may be associated with different classes. In some embodiments, training data sets may include a set of text descriptions (e.g., words, labels, sentences, phrases, or combinations thereof) corresponding to the set of images.

In turn, the outputs 410 generated by MLA vision-based NNM 404 are configured to include image segments, such as pixel values corresponding to a masked region of an image, including image regions inside and outside an image. In some examples, outputs 410 may include the generation of enhanced images by inserting pixel values corresponding to the image segment into the original image. In some other examples, outputs 410 may include generating multiple images, such as generating multiple versions of an enhanced image. In some other examples, outputs 410 may include iteratively regenerating an image, such as, using generated enhanced images as inputs to the machine learning model, and processing multiple points of view from the same physical object by using multiple frames sampled from the live stream video. For example, an enhanced image may be generated to adjust a feature within an image given a first text prompt, and the enhanced image may be provided again to the machine to adjust another feature.

The outputs 410 generated by MLA vision-based NNM 404 are configured to be forwarded to an updating model 412. The updating model 412 operates to update the MLA vision-based NNM 404 by adjusting parameters within the machine learning model, providing further training data to the machine learning model, and/or providing feedback to the machine learning model. In the disclosed implementation, the training of the machine learning model may include updating the model with real-life images captured by system 100 to improve and refine the model and the outputs generated by the model based on actual real world data, in which new samples are added on a regular basis to improve the quality of our datasets. This enables the ability to leverage the current models used to dynamically identify relevant data. The output images may include multiple versions of the enhanced image, such as different versions of the enhanced image with minor differences between the versions. As such, a user may be able to provide feedback regarding the generated enhanced images.

Therefore, as noted above, MLA vision-based NNM 404 is configured to receive and process RoI sub-image data having a reduced pixel size number to increase the processing speeds for detecting the OoI with optimal accuracy. As a result, the increased processing speed allows for the NNM 404 to process multiple sample points of the view of RoI sub-image data to increase the accuracy of OoI detection to over 99% while still delivering near real-time (e.g., on the order of a fraction of a second) status updates of driving operations.

As noted above, machine learning models, such as NNM 404, may incorporate addition models/submodels to perform certain processing tasks. Accordingly, NNM 404 is configured with an object detection model for identifying certain images related to traffic-related signs, such as, for example, pedestrians, cyclists, speed signs, road work zone signs, lane closure signs, directional signs, toll signs, detour signs, etc. The object detection model may comprise known techniques, such as, for example, regional-based convolutional neural network (RCNN), Fast-RCCN, Faster-RCCN, Single Shot Detector, You Only Look Once (YOLO) detector, etc.

The NNM 404 is also configured with a segmentation model for identifying certain images related to drivable areas, such as, for example, roads, streets, lanes, highways, etc. The segmentation model may comprise known techniques, such as, for example, U-net, DeepLab, Mask-RCNN, Twinlitenet, etc.

The NNM 404 is further configured or associated with a separate ensemble set of classifier models for the output of the object detector regarding the tracked OoI images. The ensemble classifier models are configured to improve accuracy of tracked OoI images as well as execute multiple classification processing runs based on multiple viewpoints of the same physical OoI object to enhance the independence of each sample for inference in order to minimize the common-mode error rate. For example, separate classifiers may be used to infer (i) a discrete value attribute for the speed limit (ex. 25, 30, 50, 100, and the like); (ii) a modality attribute (ex. mandatory, or recommended); (iii) a sign-type attribute (ex. school zone sign, construction zone sign, ads sign, etc.); (iv) a disambiguation attribute (ex. a speed sign versus a road shield). In some embodiments, the outputs of these classifiers are combined to yield a validated regulatory value for the detected sign. To further mitigate correlated failure modes and improve true-positive rate, the different classifiers may be trained and validated on independent datasets and/or operate with differing input configurations (e.g., input size in pixels and color-channel sets), thereby promoting error independence across the models. By employing classifiers that are trained on different data distributions and/or validated separately, correlated failure modes may be reduced, thereby further minimizing common-mode error and improving robustness of OoI classification. The ensemble set of classifier models is also used to identify images related to hazardous road conditions, such as, for example, snow, ice, standing water, immobile vehicle, road obstacles, road potholes, etc. The ensemble set of classifier models may comprise known techniques, such as, for example, ResNet, Inception, ImageNet, etc.

Once the OoI is detected, autonomous monitoring system 100 tracks the OoI during travel while monitoring the driving operations of the vehicle 102 to ensure compliance of local rules and regulations, as identified or inferred by the signage text of the detected OoI. The monitored driving operations status is forwarded to the driver on a near real-time basis (e.g., on the order of a fraction of a second) via the notification device 106 for immediate driver response. The notification device 106 may comprise a visual display device, an auditory device, a driver cellphone, or any suitable device capable of providing information to the driver.

In some embodiments, autonomous monitoring system 100 is configured with override control of the driving operations. In particular, controller 110 is communicatively-coupled to an accelerator pedal, accelerator pedal controller 108, or an electronic engine control unit (ECU) of vehicle 102. In this embodiment, the communication between controller 110 and the accelerator pedal, accelerator pedal controller 108, or ECU is based on detecting electrical analog or digital pulse width modulation (PWM) signals generated by the accelerator pedal. (See, US Pub. No. 2024/02253624, having common assignee and inventors, which is hereby incorporated by reference in its entirety.) Accordingly, upon the autonomous monitoring system 100 determining that vehicle 102 is operating at excessive speeds in view of certain identified circumstances (e.g., speed limit signs, roadwork zone signs, hazardous road and/or weather conditions, etc.), the controller 110 detects the electrical analog and/or digital signals generated by the accelerator pedal and takes overriding control of the accelerator pedal to limit the speed of vehicle 102 to acceptable levels throughout the identified circumstances.

Thus, by virtue of processing RoI sub-image data having a reduced pixel size number to detect the OoI with optimized processing speed and accuracy, autonomous monitoring system 100 is capable of providing near real-time overriding vehicle speed control within a fraction of a second to ensure safe driving operations.

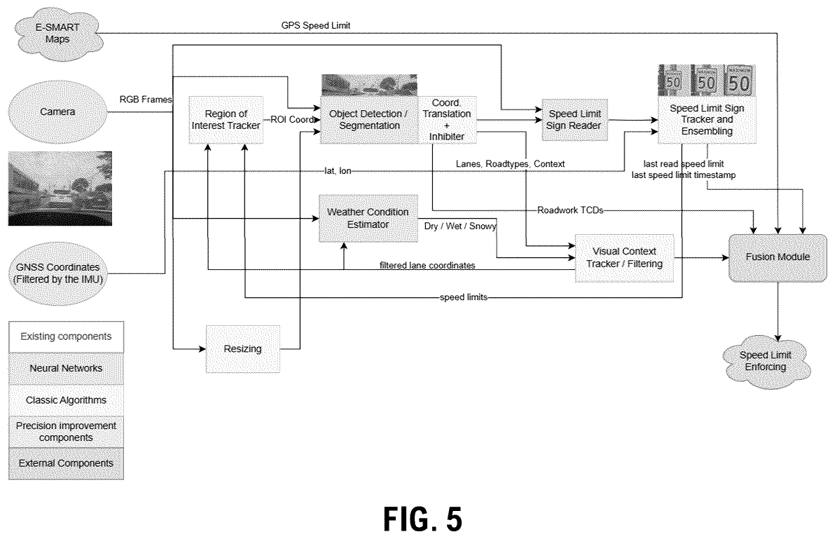

To this end, FIG. 5 depicts a nonlimiting exemplary high-level general configuration of system 100, in accordance with embodiments of the present technology. FIG. 5 illustrates a general overview of the interoperability between the various components of system 100.

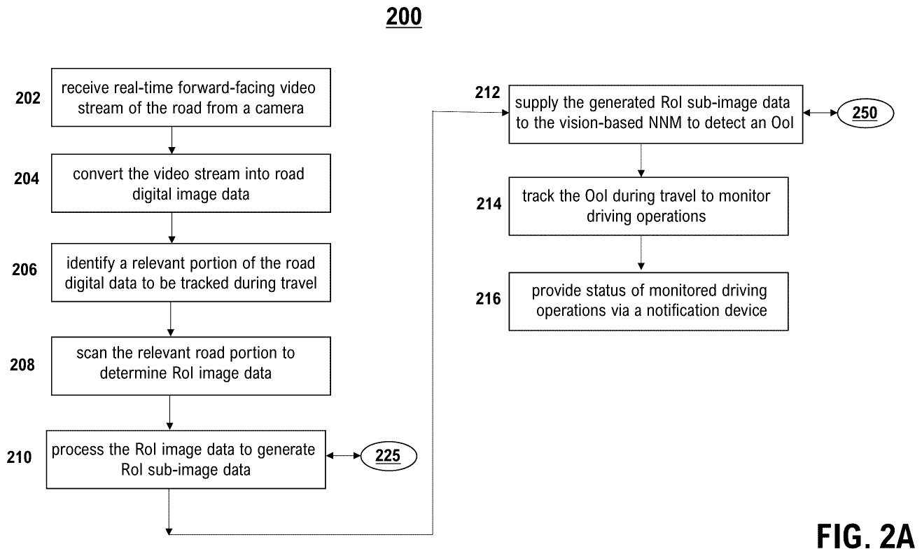

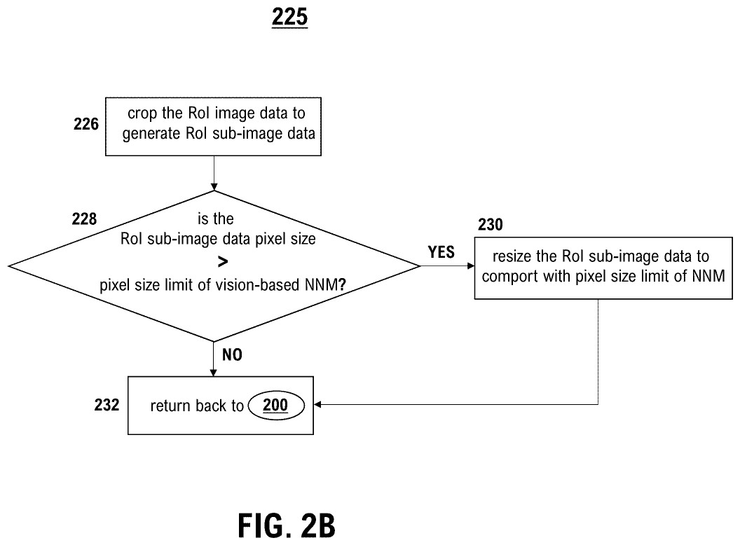

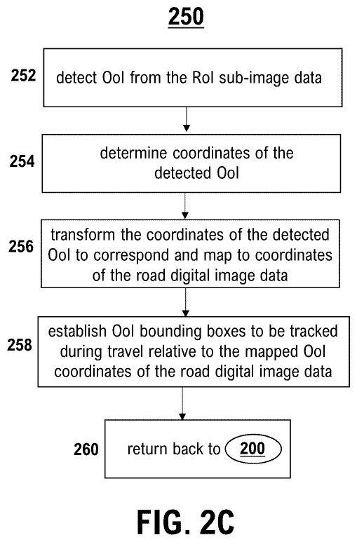

Given the noted configuration of autonomous monitoring system 100, FIG. 2A depicts main process 200 for autonomously monitoring driving operations of vehicle 102, in accordance with embodiments of the present technology.

Main process 200 commences at task block 202, where the real-time forward-facing video stream is received and at task block 204, the video stream is converted into road digital image data. As noted above, camera 104 captures a real-time, forward-facing video stream of the road currently-traveled by vehicle 102 that is received by controller 110 that is converted to road digital image data having an RGB (1920×1080) format that is suitable for vision-based neural network processing.

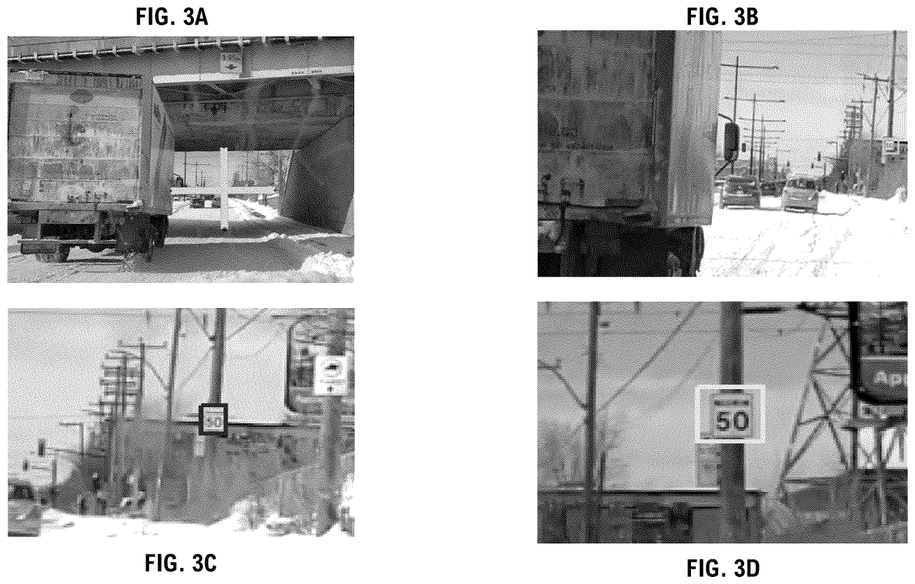

At task block 206, a relevant portion of the road digital data to be tracked during travel is identified. The identified relevant portion of the road focuses on a segment of the road digital image data that is determined to likely contain a RoI within the road digital image data, such as, for example, the center of the road (see, FIG. 3A).

At task block 208, the relevant road portion is scanned to determine RoI image data (see, FIG. 3B). The RoI represents a region of the road digital image data that is to be processed by the vision-based NNM 404, instead of processing the entire RGB (1920×1080) road digital image data. As noted above, the RoI image data may be determined by scanning various portions of the identified relevant portion of the road, such as, for example scanning top left, top right, bottom left, bottom right, and center portions and/or scanning the relevant portion of the road from top to bottom in a V-shaped pattern.

After the RoI image data is determined, at task block 210, the RoI image data is processed to generate RoI sub-image data. As noted above, the generated RoI sub-image data comprises cropped RoI image data to provide RoI sub-image data focusing on the RoI with a reduced pixel size number. The generation of the RoI sub-image data will be described in greater detail below relative to process 225.

Once the RoI sub-image data is generated, at task block 212, it is supplied to the vision-based NNM to detect an OoI. As also noted above, the detection of the OoI comprises identification of certain road-related artifacts (e.g., traffic signs, drivable areas, hazardous road conditions, etc.) as well as determination of OoI coordinates within the RoI sub-image data. The determination of the OoI will be described in greater detail below relative to process 250.

At task block 214, the OoI is tracked during travel to monitor driving operations and at task 216, the status of the monitored driving operations forwarded to the driver in a near real-time basis.

In some embodiments, in an initial search mode (such as at startup or after loss of track), the controller 110 performs a structured evaluation to obtain the RoI. In one approach, a coarse context pass is first performed by downscaling a copy of the full 1920×1080 frame to 512×160 to obtain a low-cost overview of the scene layout to identify the center of the road (or REBR). Using the coarse pass to seed locations (such as the REBR) in the original-resolution frame by mapping back the REBR coordinates to the full-resolution frame, the controller 110 then enumerates candidate sub-windows of 1024×320 pixels within the selected region and resamples them to 512×160 before supplying it to the NNM 404. The candidates are evaluated in a deterministic V-pattern (e.g., left-of-center, right-of-center, bottom-center) and the process is repeated until a lane cue or a traffic sign/object is detected with sufficient confidence.

In some embodiments, the controller 110 operates according to multiple operational modes governing determination and update of the RoI, including at least the search mode (as briefly mentioned above), and a tracking mode (described in more detail below). The operational mode may be selected dynamically based on detection results generated by the NNM 404 and, in some cases, on a confidence metric associated therewith.

In the search mode, which may be executed during initialization or following a loss or invalidation of a previously detected OoI, the controller 110 performs a structured evaluation to identify candidate RoIs. In some embodiments, the structured evaluation comprises scanning the REBR in a V-pattern as described above.

Upon detection of an OoI satisfying a confidence criterion, the controller 110 transitions to the tracking mode. In the tracking mode, the RoI is iteratively updated based on prior detection results such that the RoI is centered on, or otherwise spatially aligned with, a most recent detected location of the OoI. Each iteration of detection thereby informs a subsequent RoI selection, forming a closed loop process in which detection output drives RoI determination for a subsequent frame.

On the other hand, if the confidence score degrades or fails to meet a predetermined criteria, the controller 110 may modify the RoI, or revert to the search mode to reacquire the OoI. Accordingly, RoI selection and operational mode may be dynamically updated.

In some embodiments, the size of the RoI is dynamically adjusted by the controller 110 as a function of the operational mode. During the search mode, the RoI may be expanded to cover a larger portion of the road digital image data in order to increase the likelihood of detecting the OoI by the NNM 404. By contrast, during the tracking mode, the RoI may be reduced in size once the OoI is being reliably tracked, thereby focusing processing resources on a more localized image region.

Conversely, when detection confidence degrades, becomes inconsistent, or when the OoI exhibits increased positional uncertainty, the controller 110 may enlarge the RoI or revert to a broader search region. In this manner, the RoI size may be dynamically increased to recover from tracking loss or ambiguity, thereby improving robustness under varying environmental conditions.

It should be understood that the adaptive selection of the RoI, including dynamic adjustment of its size as described above is performed prior to adapting the RoI to the input requirements of the NNM 404.

FIG. 2B depicts process 225 for generating RoI sub-image data, in accordance with embodiments of the present technology. As shown, at task block 226, the RoI image data (received from task block 210 of process 200) is cropped to generate RoI sub-image data (see, FIG. 3C). The cropping of the RoI image data comprises disregarding pixels of the road digital image data that contain image data outside of the focused RoI, such that the generated RoI sub-image data comprises a reduced pixel size that is focused on the RoI.

At decision block 228, it is determined whether the RoI sub-image data pixel size is greater than the pixel size limit of vision-based NNM 404. As discussed above, vision-based NNM 404 is premised on a machine AI deep learning platform 400 configured to receive and process RoI sub-image data having a reduced pixel size number to optimize processing speeds in detecting an OoI. That is, by limiting the pixel size of the focused RoI sub-image data to be processed by NNM 404, system 100 is capable of providing near real-time status updates of driving operations. If the RoI sub-image data pixel size is not greater than the pixel size limit of vision-based NNM 404, process 225 returns back to task block 210 of process 200. However, if it is greater than NNM pixel size limit, process 225 advances to task block 230 to resize the RoI sub-image data to comport with pixel size limit of NNM 404. Resizing techniques may include, down-sampling, adjusting scaling factor, adjusting resolution and may also include maintaining the same aspect ratio as the road digital image data. After resizing, at task block 232, process 225 returns back to task block 210 of process 200.

FIG. 2C depicts process 250 for detecting an object-of-interest (OoI), in accordance with embodiments of the present technology. As shown, at task block 252, the RoI sub-image data (received from task block 212 of process 200) is processed by vision-based NNM 404 to detect an OoI (see, FIG. 3D). The OoI may comprise traffic-related signs, drivable areas, and/or hazardous road conditions. Accordingly, NNM 404 may be configured with an object detection model for identifying certain images related to traffic-related signs. The object detection model may comprise known techniques, such as, for example, regional-based convolutional neural network (RCNN), Fast-RCCN, Faster-RCCN, Single Shot Detector, You Only Look Once (YOLO) detector, etc.

Relatedly, NNM 404 may also be configured with a segmentation model for identifying certain images related to drivable areas, such as, for example, roads, streets, lanes, highways, etc. The segmentation model may comprise known techniques, such as, for example, U-net, DeepLab, Mask-RCNN, Twinlitenet, etc.

Additionally, NNM 404 may be further configured with an image classification model for identifying certain images related to hazardous road conditions, such as, for example, snow, ice, standing water, immobile vehicle, road obstacles, road potholes, etc. The image classification model may comprise known techniques, such as, for example, YoloP, ResNet, Inception, ImageNet, etc.

After the OoI is detected, at task block 254, the coordinates of the detected OoI within the cropped RoI sub-image data are determined and, at task block 256, the OoI coordinates are transformed to correspond and map to the road digital image data.

At task block 258, bounding boxes around the OoI may be established to facilitate tracking of the OoI relative to the corresponding mapped coordinates of the road digital image data during travel. As noted above, the tracked OoI images may be forwarded to ensemble classifier models to improve accuracy as well as execute multiple classification processing runs based on multiple viewpoints of the same physical OoI object to enhance the independence of each sample for inference in order to minimize the common-mode error rate.

In some embodiments, outputs of the detection are further processed according to a coordinate transformation and validation chain to support context-aware operational decisions, as described below.

In some embodiments, the OoI detected by the NNM 404 is first expressed in image-space coordinates (i.e. bounding boxes in pixels). These coordinates are then transformed to the vehicle reference frame, using camera calibration parameters and ego-motion information. The resulting vehicle-frame state may be semantically validated (e.g., via the ensemble classifiers described herein) and, in some embodiments, associated with a corresponding map object (e.g., road segment, lane, or ramp). The validated, context-aware state is then used by the controller 110 to drive operational decisions, including whether to update an internal regulatory speed state, to ignore an ambiguous detection, or to initiate an override/limitation of vehicle speed.

In some embodiments, as part of the reprojection to the vehicle reference frame described above, the controller 110 computes a reprojection of the OoI from image space to the vehicle reference frame using known camera parameters together with ego-motion signals (e.g., vehicle pose/orientation and/or odometry/IMU). The reprojection yields a relative position of the detected OoI with respect to the vehicle (e.g., longitudinal distance and lateral offset), thereby enabling the controller 110 to reason about applicability in the vehicle's physical context rather than solely in pixel coordinates.

In some embodiments, the vehicle-frame state of the detected OoI is associated with a corresponding map object, such as a particular road segment, lane, ramp, or service road proximate to the vehicle. This object map-matching can be used to resolve ambiguous cases by constraining applicability to the correct roadway context. For example, a “50” speed sign visible from a highway may be ignored by the controller 110 when the map association indicates that the sign is associated with a nearby service road limited to 50, rather than the highway mainline.

Accordingly, in some embodiments, the controller 110 implements a detection-to-decision pipeline in which an OoI is detected in image space, reprojected into the vehicle reference frame, associated with a corresponding map object (object map-matching), validated and used to drive the operational decisions.

Then, at task block 260, process 250 returns back to step 212 of process 200 to continue the autonomous monitoring of driving operations.

In some embodiments, in a lane-tracking mode, upon the NNM 404 detecting a lane cue, the controller 110 is configured to maintain a stabilized estimate of lane position and derives subsequent RoIs in a neighborhood around that estimate. In one approach, the center of detected lane bounding outputs are aggregated over time using a rolling average to smooth jitter and occlusions. Using the smoothed lane center in the original resolution frame, the controller 110 enumerates candidate sub-windows of 1024×320 pixels within the selected region, resamples each candidate to 512×160, and supplies them to the neural network.

In some embodiments, in a sign-tracking mode, upon the NNM 404 detecting a traffic sign, the region of interest is iteratively recentered at maximum digital zoom on the last detected sign location by cropping directly to the network input size (e.g., 512×160). The controller supplies this cropped view to the NNM 404 each frame and recenters again based on the updated detection.

In other words, the lane-tracking mode and sign-tracking mode execute the RoI selection in a closed loop, such that each detection result informs the RoI proposed for the next frame.

The lane-tracking mode and sign-tracking mode described herein may be understood as non-limiting examples of the tracking mode in which the RoI is iteratively updated based on prior detection results. In such modes, each detection performed by the controller 110 informs the spatial positioning of the RoI for a subsequent frame, thereby enabling sustained tracking of the OoI over time with reduced computational overhead.

In this manner, the disclosed non-limiting embodiments of the present technology are directed to a system and computer-implemented method for providing vehicles with expeditious, responsive, and cost-sensitive autonomous safety monitoring features.

While the above-described implementations have been described and shown with reference to particular steps performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It will be appreciated that modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A system for autonomously monitoring and/or controlling driving operations of a vehicle, comprising:
a controller communicatively-coupled to an associated memory unit, the controller configured with computer executable instructions to operatively:
receive a real-time forward-facing video stream of a currently-traveled road from a camera;
convert the real-time video stream into road digital image data;
generate, from the road digital image data, a downscaled representation of a full-resolution frame to obtain a coarse overview of the road digital image data;
identify a relevant portion of the road to be tracked during travel based on the coarse overview of the road digital image data by defining a road-end bounding region derived from detected road geometry;
mapping the road-end bounding region to the full-resolution frame;
determine region-of-interest (RoI) image data, wherein to determine the RoI image data, the controller is configured to scan the road-end bounding region mapped to the full-resolution frame from top to bottom in a V-shaped pattern;
crop the RoI image data to provide RoI sub-image data comprising a reduced pixel number size of the road digital image data;
supply the cropped RoI sub-image data to a vision-based machine-learning algorithm (MLA) trained to detect an object-of-interest (OoI);
track the detected OoI during travel to monitor the driving operations of the vehicle; and
generate status of the monitored driving operations on a near real-time basis.

2. The system of claim 1, wherein the MLA comprises a vision-based neural network module (NNM).

3. The system of claim 1, wherein the near real-time basis comprises less than 1 second.

4. The system of claim 1, further comprising a notification device communicatively-coupled to the controller to receive and report the near real-time status of the monitored driving operations, wherein the notification device comprises at least one of a visual display device, an auditory device, and a driver cellphone.

5. The system of claim 1, wherein the controller is configured to detect electrical analog or electrical digital signals generated by a vehicle acceleration pedal to override driving operations of a driver by limiting a speed of the vehicle based on the monitored driving operations status.

6. The system of claim 1, wherein the road-end bounding region serves as a seed region within which the V-shaped pattern scan is executed.

7. The system of claim 2, wherein the NNM is configured to operate on images having a pixel number size less than the road digital image data to optimize processing speed.

8. The system of claim 1, wherein the cropping of the RoI image data comprises disregarding pixels of the road digital image data representing image data outside of the RoI.

9. The system of claim 1, further comprising resizing of the cropped RoI sub-image data to provide a reduced number of pixels of the cropped RoI sub-image data.

10. The system of claim 9, wherein the resizing of the cropped RoI sub-image data comprises maintaining a same aspect ratio as the road digital image data.

11. The system of claim 1, further comprising determining coordinates of the detected OoI within the cropped RoI sub-image data and transforming the coordinates of the detected OoI to correspond to the road digital image data.

12. The system of claim 2, wherein the detected OoI comprises traffic-related signs including one or more of speed signs, road work zone signs, lane closure signs, directional signs, toll signs, and detour signs.

13. The system of claim 12, wherein the NNM incorporates an ensemble set classifier models for detecting and tracking OoI images, the ensemble set of classifier models configured to execute multiple classification processing runs based on multiple viewpoints of the tracked OoI image to enhance independence of each sample for inference to minimize common-mode error rates.

14. The system of claim 13, wherein the ensemble of classifiers includes at least one classifier inferring:
a discrete value attribute for a speed limit;
a modality attribute;
a sign-type attribute;
a disambiguation attribute
and wherein, an output of the at least one classifier being used to determine a validated regulatory value of the tracked OoI.

15. The system of claim 2, wherein the OoI comprises hazardous road conditions including one or more of snow, ice, standing water, immobile vehicle, road obstacles, and road potholes.

16. A computer-implemented method for autonomously monitoring driving operations of a vehicle, the method executable by a controller comprising a processor, the method comprising:
receiving a real-time forward-facing video stream of a currently-traveled road;
converting the real-time video stream into road digital image data;
generating, from the road digital image data, a downscaled representation a full-resolution frame to obtain a coarse overview of the road digital image data;
identifying a relevant portion of the road to be tracked during travel based on the coarse overview of the road digital image data by defining a road-end bounding region derived from detected road geometry;
mapping the road-end bounding region to the full-resolution frame;
determining region-of-interest (RoI) image data, wherein the determining of the ROI image data comprises scanning the road-end bounding region mapped to the full-resolution frame from top to bottom in a V-shaped pattern;
cropping the RoI image data to provide RoI sub-image data comprising a reduced number of pixels of the road digital image data;
supplying the cropped RoI sub-image data to a machine-learning algorithm (MLA) trained to detect an object-of-interest (OoI);
tracking the detected OoI during travel to monitor the driving operations of the vehicle; and
generating near real-time status of the monitored driving operations.

17. The method of claim 16, wherein the near real-time status comprises less than 1 second.

18. The method of claim 16, further comprising reporting the near real-time status of the monitored driving operations via a notification device communicatively-coupled to the controller, the notification device comprising at least one of a visual display device, an auditory device, and a driver cellphone.

19. The method of claim 16, further comprising detecting, by the controller, electrical analog or electrical digital signals generated by a vehicle acceleration pedal and overriding driving operations of a driver by limiting a speed of the vehicle based on the monitored driving operations status.

20. A non-transitory computer readable medium comprising instructions which, when executed by at least one processor, cause the at least one processor to carry out steps of a method for autonomously monitoring driving operations of a vehicle, the method comprising:
receiving a real-time forward-facing video stream of a currently-traveled road;
converting the real-time video stream into road digital image data;
generating, from the road digital image data, a downscaled representation a full-resolution frame to obtain a coarse overview of the road digital image data;
identifying a relevant portion of the road to be tracked during travel based on the coarse overview of the road digital image data by defining a road-end bounding region derived from detected road geometry;
mapping the road-end bounding region to the full-resolution frame;
determining region-of-interest (RoI) image data, wherein the determining of the ROI image data comprises scanning the road-end bounding region mapped to the full-resolution frame from top to bottom in a V-shaped pattern;
cropping the RoI image data to provide RoI sub-image data comprising a reduced number of pixels of the road digital image data;
supplying the cropped RoI sub-image data to a machine-learning algorithm (MLA) trained to detect an object-of-interest (OoI);
tracking the detected OoI during travel to monitor the driving operations of the vehicle; and
generating near real-time status of the monitored driving operations.
